(19) United States
(12) Patent Application Publication
(10) Pub. No.: US 2014/0367437 A1
(43) Pub. Date: Dec. 18, 2014

(54) BICYCLE VEHICLE INTERIOR MOUNTING SYSTEM

(71) Applicant: Berardino D' Angelo, Collingswood, NJ (US)

(72) Inventor: Berardino D' Angelo, Collingswood, NJ (US)

(21) Appl. No.: 13/939,388

(22) Filed: Jul. 11, 2013

Related U.S. Application Data
(60) Provisional application No. 61/836,647, filed on Jun. 18, 2013.

(51) Int. Cl. B60R 11/00

(52) U.S. Cl. CPC B60R 11/00
USPC 224/567

(57) ABSTRACT

A bicycle mounting system is provided having a base board with a flat top, a threaded aperture, and an alignment feature. A removable fork mount includes a first lug extending from a first side, a second lug extending from a second side and a threaded fastener for removably attaching the fork mount to the base board. The threaded fastener has a knob to enable attaching and removing the fork mount without tools. A contact fastener on the base board attaches the system to a vehicle.

### CROSS REFERENCE TO RELATED APPLICATION(S)

This application claims the benefit of U.S. provisional application No. 61/836,647, filed Jun. 18, 2013, which is incorporated by reference as if fully set forth.

### BACKGROUND

Around the world bicycles are the most widely used commuting vehicles. Bicycles are used by hundreds of millions of people every day for basic transportation. In the United States bicycling ranks as one of the most popular activities for young and old alike. While in the United States bicycles are not as widely used for commuting as in some other countries, bicycles are nonetheless used by millions daily.

The love of bicycling often starts at an early age. Whether by learning using training wheels; by having a parent run alongside as you learn to balance, pedal, and stop; or simply by trial and often painful error learning to ride a bike is a common signpost of growing up.

Once a person learns how to ride, other uses for bicycles become available. Bicycles can be used for health, losing weight, commuting, recreation, sightseeing, competition, to save money, to reduce pollution, and generally to enjoy a more satisfying life away from the congestion of freeways.

Given the popularity of bicycles, their small size and light weight, as well as their high cost it is not surprising that over a million bicycles are stolen every year in the United States. Since many bicycles cost well over a thousand dollars it is no surprise that security is a major concern of bicycle owners. Even less expensive bikes are highly valued by their owners and by thieves.

Bicycle security is essentially about preventing theft. Bicycle locks, chains and brackets are common. Removing the front wheel and possibly both wheels tends to reduce theft and is often done for just that reason. However, taking your bicycle with you is still probably the most secure way to prevent theft. Thus many owners store their bicycles in their offices, homes, gyms, or garages. While such on-site storage is successful in reducing theft it is not always possible.

Safely securing your bicycle to your vehicle to prevent theft while traveling is particularly difficult. Common methods of transporting bicycles include roof mounted bicycle carriers and rear-bumper mounted bicycle carriers. Holding a bike overhead while trying to attach it to a roof mounted bicycle carrier can result in damage to the vehicle, the bicycle, or both because of loss of control. If a stool is needed and loss of balance results injury to the bicycle owner may also result.

Pulling into parking garages (home and commercial) that may be too low can cause damage to the vehicle, the bicycle, and the building. Street parking while leaving your bicycle unattended may result in stolen bikes, particularly when using rear mounted bicycle carriers. In addition, rear mounted bicycle carriers can make it almost impossible to park on the street and even in some indoor lots. Backing up to park can result in damage to your vehicle, bikes and neighboring vehicles. When traveling, a bicycle owner might stop at a restaurant or overnight at a motel. This requires that the bike or bikes be taken inside or the bicycle is ripe for theft.

In view of the high cost of bicycles it pays to “put your ride inside” your vehicle when traveling. Therefore, a bicycle vehicle interior mounting system that places a bicycle or bicycles inside a vehicle would be beneficial.

### SUMMARY

This Summary introduces simplified concepts that are further described below in the Detailed Description of Illustrative Embodiments. This Summary is not intended to identify key features or essential features of the claimed subject matter and is not intended to be used to limit the scope of the claimed subject matter.

Described herein are bicycle vehicle interior mounting systems that enable placement of one or more bicycles inside a vehicle. A bicycle vehicle interior mounting system reduces the temptation of stealing the bicycle or bicycles by would be thieves while also using the security of being inside the vehicle to protect the bicycle or bicycles. The bicycle vehicle interior mounting systems are configured to minimally impact the use of the vehicle when a bicycle is not being transported. Furthermore, the bicycle vehicle interior mounting systems are easily installed in a wide range of vehicles.

A bicycle mounting system is provided which includes a base board having a contact fastener and a fork mount that is removably connected to the base board. The fork mount includes a first bearing surface, a second bearing surface, and a third bearing surface that is located opposite the second bearing surface. A first threaded member having a first hand knob extends from the first bearing surface, a second threaded member having a second hand knob rotatable relative to the second bearing surface and translatable to and from the second bearing surface extends from the second bearing surface, and a third threaded member having a third hand knob rotatable relative to the third bearing surface and translatable to and from the third bearing surface extends from the third bearing surface. The fork mount is removably connected to the base board by the first threaded member such that the first bearing surface is in contact with the base board opposite the contact fastener.

That bicycle mounting system can use a contact fastener having an adhesive, a hook portion of a hook and loop fastener or a loop portion of a hook and loop fastener. The base board can include a threaded hole that mates with the threads on the first threaded member. In practice the base board includes at least one alignment feature while the fork mount comprises at least one alignment feature that is configured to mate with the at least one alignment feature of the base board for positioning the fork mount relative to the base board. The alignment feature of the base board can be an opening, while the alignment feature of the fork mount can be a projection configured for positioning in the opening. Preferably the alignment feature of the base board comprises at least two openings and the alignment feature of the fork mount comprises at least two projections configured for positioning in the at least two openings. In practice, the first threaded member passes through the fork mount while the bicycle mounting system further includes a wheel anchor comprising a sheet of material, a strap connected to the sheet of material, and a contact fastener connected to the material. Preferably the sheet of material is flexible and the contact fastener comprises at least one of an adhesive, a hook portion of a hook and loop fastener, and a loop portion of a hook and loop fastener.

An alternative bicycle mounting system includes a base board having a contact fastener and a fork mount that is removably connected to the base board. The fork mount has a first bearing surface, a second bearing surface, a first threaded member having a first hand knob, a second threaded member extending from the second bearing surface; and a second hand knob connected to the second threaded member and rotatable relative to the second bearing surface and translatable to and from the second bearing surface. The fork mount is removably connected to the base board by the first threaded member with the first bearing surface in removable contact with the base board opposite the contact fastener.

The alternative bicycle mounting system can include a third bearing surface opposite the second bearing surface such that the first threaded member is disposed between the second bearing surface and the third bearing surface. The third threaded member then extends from the third bearing surface in substantially axially alignment with the second threaded member. A third hand knob is connected to the third threaded member and rotatable relative to the third bearing surface and translatable to and from the third bearing surface.

In another alternative bicycle mounting system, that system has a base board with a board bottom, a substantially flat board top, a perimeter edge, and an angled lip extending upward from the edge to the board top. The base board further includes a threaded aperture into the board top and a stabilizing pin hole located adjacent the threaded aperture. A contact fastener is located on the board bottom. Also included is a fork mount having a body with a first side, a second side, a mount top, and a mount bottom. The fork mount further includes a first threaded lug extending from the first side, a second threaded lug extending from the second side, a first knob threaded onto the first threaded lug, and a second knob threaded onto the second threaded lug. The fork mount further includes a stabilizing pin extending from the mount bottom and a threaded fastener that passes through the body from the mount top and extends from the mount bottom. The threaded fastener screws into the threaded aperture to attach the fork mount to the base plate such that the stabilizing pin fits into the stabilizing pin hole when the threaded fastener screws into the threaded aperture.

In this other alternative bicycle mounting system, the threaded fastener includes a hand knob that assists screwing the threaded fastener into the threaded aperture. Beneficially the contact fastener includes adhesive and at least one of a hook fastener and a loop fastener. A skid/scuff pad for anchoring a wheel of a bicycle opposite the bicycle fork. The skid/scuff pad comprises a sheet of material, a strap connected to the sheet of material, and a contact fastener connected to the sheet of material. That strap can include a set of hook-and-loop fasteners.

Further provided is a dual bicycle mounting system. Such a dual bicycle mounting system includes a base board having a board bottom, a substantially flat board top, a perimeter edge, and an angled lip extending upward from the edge to the board top. That base board further includes a first threaded aperture into the board top, a first stabilizing pin hole adjacent the first threaded aperture, a second threaded aperture into the board top, and a second stabilizing pin hole adjacent the second threaded aperture. A contact fastener is on the board bottom. The dual bicycle mounting system further includes at least one fork mount having a body with a first side, a second side, a mount top, and a mount bottom. The at least one fork mount further includes a first threaded lug extending from the first side, a second threaded lug extending from the second side, a first knob threaded onto the first threaded lug, and a second knob threaded onto the second threaded lug. The at least one fork mount further includes a stabilizing pin extending from the mount bottom and a threaded fastener passing through the body from the mount top that extends from the mount bottom. The threaded fastener screws into the first threaded aperture to attach the at least one fork mount to the base plate such that the stabilizing pin fits into the first stabilizing pin hole when the threaded fastener screws into the first threaded aperture.

In the dual bicycle mounting system the threaded fastener can include a hand knob that assists screwing the threaded fastener into the first threaded aperture. The contact fastener can include an adhesive and at least one of a hook fastener and a loop fastener. The dual bicycle mounting system can include a skid/scuff pad comprising a sheet of material, a strap connected to the sheet of material, and a contact fastener connected to the sheet of material. That strap can include a set of hook-and-loop fasteners.

Yet another alternative bicycle mounting system includes a base board having a board bottom, a substantially flat board top, a perimeter edge, and an angled lip extending upward from the edge to the board top. That base board further includes a threaded aperture into the board top and a stabilizing pin hole located adjacent the threaded aperture. A contact fastener is on the board bottom. That alternative bicycle mounting system includes a fork mount having a body with a first side, a second side, a mount top, and a mount bottom. The fork mount further includes a first fork receiving member extending from the first side and a second fork receiving member extending from the second side. The fork mount further includes a stabilizing pin extending from the mount bottom and a threaded fastener passing through the body from the mount top and extending from the mount bottom. The threaded fastener screws into the threaded aperture to attach the fork mount to the base plate such that the stabilizing pin fits into the stabilizing pin hole when the threaded fastener screws into the threaded aperture.

### BRIEF DESCRIPTION OF THE DRAWING(S)

A more detailed understanding may be had from the following description, given by way of example with the accompanying drawings. The Figures in the drawings and the detailed description are examples. The Figures and the detailed description are not to be considered limiting and other examples are possible. Like reference numerals in the Figures indicate like elements wherein:

FIG. 1 illustrates a single bicycle vehicle interior mounting system 10 installed in a vehicle 12;

FIG. 1A illustrates a skid/scuff pad 16 with strap 24 used in the mounting system 10 for anchoring a rear bicycle wheel 18;

FIG. 2 shows a base board 20 and a fork mount 22 used in the mounting system 10;

FIG. 3 depicts a close-up exploded view of the base board 20 and a fork mount 22 shown in FIG. 2;

FIG. 4 depicts a hook-and-loop fastener strap 24;

FIG. 5 shows the skid/scuff pad 16 with strap 24 illustrated in FIG. 1A in more detail; and

FIG. 6 illustrates a base plate 60 of a dual bicycle vehicle interior mounting system 11.

### DETAILED DESCRIPTION OF ILLUSTRATIVE EMBODIMENT(S)

The disclosed subject matter is described more fully hereinafter with reference to the accompanying drawings. In the figures like numbers refer to like elements. Furthermore, the terms “a” and “an” as used herein do not denote a limitation of quantity, but rather denote the presence of at least one of the referenced items. All documents and references referred to herein are hereby incorporated by reference for all purposes.

A single bicycle vehicle interior mounting system 10 (hereinafter “mounting system 10”) is provided that enables a user to transport and store one bicycle in the upright position inside their vehicle. Further provided is a dual bicycle vehicle interior mounting system that enables a user to transport and store two bicycles in the upright position inside their vehicle. The mounting systems enable quick, easy, secure, and protective carrying and storing of bicycles when desired while not unduly obstructing the vehicle interior when a bicycle is not being carried or stored. To achieve that end, components that might obstruct the vehicle interior when not carrying or storing a bicycle can be quickly and easily removed without tools. The mounting systems are suitable for use with a wide range of vehicles such as SUVs, station wagons, vans, pick-up trucks with caps, etc.

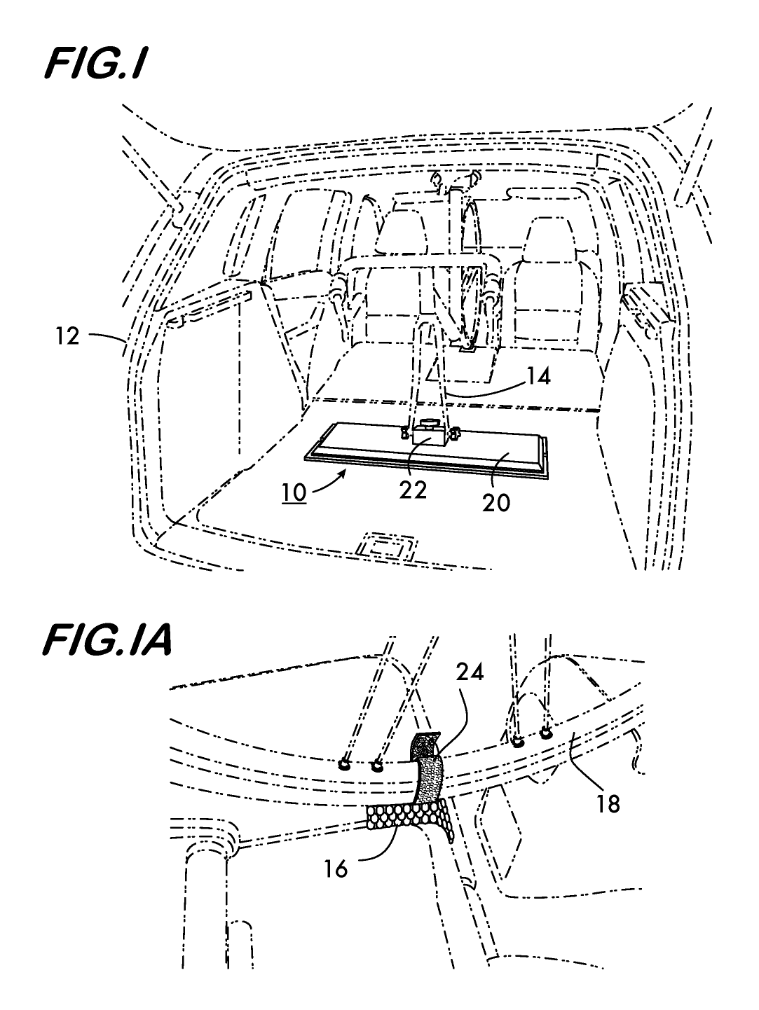

FIG. 1 illustrates the mounting system 10 installed in a vehicle 12 and holding a bicycle 14 upright. Referring to FIGS. 1-3 as required, the mounting system 10 includes a fork mount 22 that is attached to a base board 20. The bicycle 14 is held upright on the fork mount 22 after the front wheel of the bicycle 14 is removed. This is accomplished by placing the front fork of the bicycle 14 on hanger bolts 38 that extend from the sides of the fork mount 22. When the front fork of the bicycle 14 is in place threaded knobs 40 on the hanger bolts 38 can be tightened against the front fork to secure it to the fork mount 22.

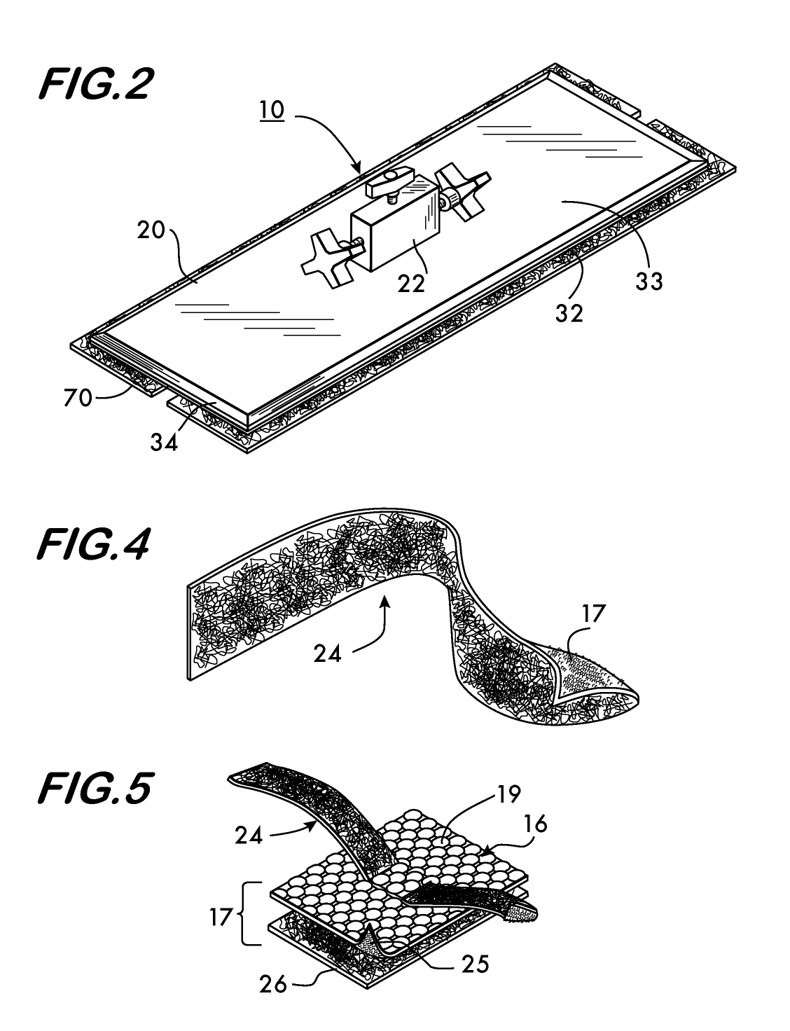

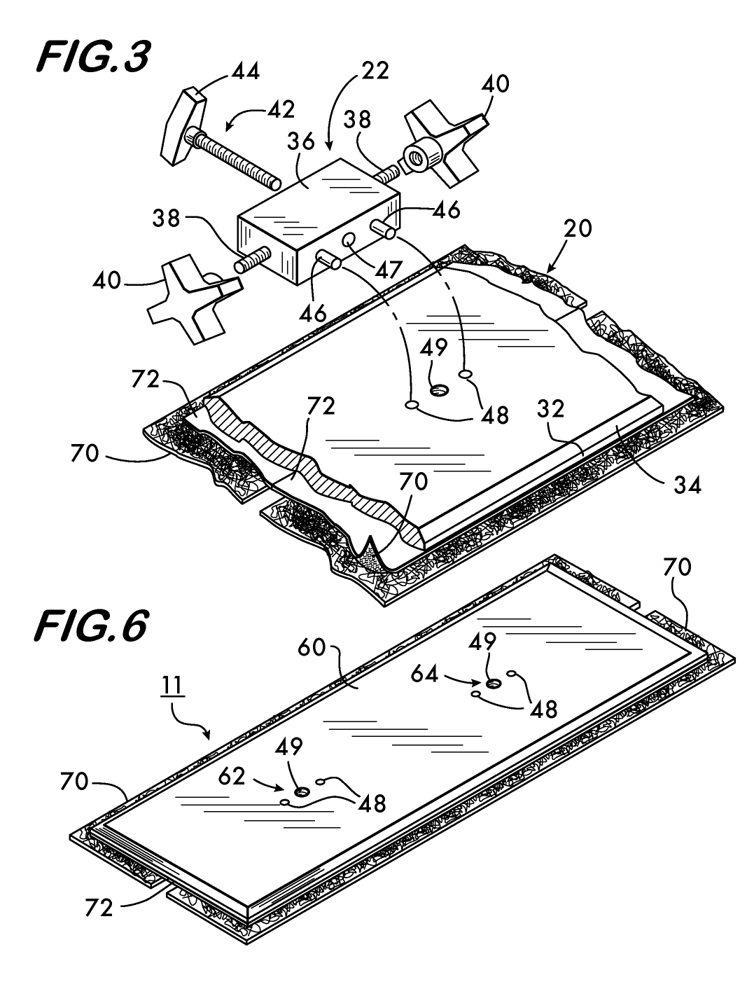

Referring now primarily to FIGS. 2 and 3, the base board 20 is beneficially a unitary piece having a substantially flat top surface 33 and a beveled lip 34 that runs along the outer perimeter edge 32 of the base board 20. As an illustrative example the base board 20 might be about 27 inches long, 8 inches wide, about ¾ inch thick at the center, have a ½ inch, 45 degree angle beveled lip 34 and a ¼ inch vertical bottom edge 32. Such a base board 20 accommodates one bicycle 14 using one fork mount 22. While the illustrated example provides useful starting dimensions, the actual dimensions of a particular implementation may vary and may depend on the vehicle in which the mount system 10 is being used.

Referring now specifically to FIG. 3, the base board 20 includes a threaded center aperture 49. If the base board 20 is comprised of a soft material that does not directly support threads an aperture 49 may be drilled/counter-sunk and then a threaded member, such as a steel nut can be glued into place. As an illustrative example of a base board 20 made from a soft material, if the base board 20 is comprised of a plastic such as HDPE (High Density Polyethylene) a 5/16 hole could be drilled through the base board and a ¼-20× 7/16 steel weld nut having a 0.75 inch base could be inserted and glued into place. The result is a threaded aperture 49

Still referring to FIG. 3, near the aperture 49 and along the center line of the base board 20 are two small stabilizing holes 48, one on either side of the aperture 49. For convenience, the aperture 49 and the stabilizing holes 48 are located and drilled using a template or a properly programmed CNC machine.

Below the base board 20 are two sets of hook-and-loop fasteners. Illustratively, each hook strip 72 can be 4 inches wide by 27 inch long and adjacently positioned on the bottom of the base board 20, and each loop strip 70 can be 4 inches wide and 28 inches long and positioned spaced apart 1 inch from each other. Thus, the loop strips 70 extend past the hook strips 72 with ½ inch aprons. When the base board 20 is installed, the loop strips 70 attach to the floor of the vehicle 12 via an adhesive, the hook strips 72 attach to the base board 20, and the base board 20 removably attaches to the vehicle 12 using the hook and loop fasteners 70 and 72. Prior to attaching the loop strips 70 to the floor of the vehicle 12, protective plastic release sheets cover the adhesive on the bottom of the loop strips 70. Ideally the loop strips 70 use an adhesive that will not leave residue if the loop strips 70 are ever removed. In cases where the floor of the vehicle 12 includes upholstery or carpeting with looped pile or other surface suitable for mating with the hook strips 72, the loop strips 70 can be omitted and the base board 20 can be directly attached to the floor of the vehicle 12 via the hook strips 72.

The fork mount 22 is beneficially made from a rectangular body 36 of HDPE plastic. For purposes of illustration, the fork mount 22 can be comprised of a rectangular body 36 of HDPE that is ¾ inch thick, 1 and ½ inch high, and 3 and ⅞ inch long.

Extending from each side of the fork mount 22 are hanger lugs 38. The hanger lugs 38 are threaded into holes drilled into ends of the body 36. For example, 5/16 holes can be drilled ⅞ inch deep into the body 36 about ⅜ inches from its top edge at two ends. Then, 2 inch long, 5/16-18 hanger bolts 38 can be installed into those holes, leaving slightly over one inch of machine thread exposed. In practice the hanger bolt 38 ends within the holes can be held in place by glue while the exposed threads receive lubricant. Templates or CNC machines can be used to locate and drill the holes. As previously noted the hanger lugs 38 receive the front forks of a bicycle 14.

A mounting bolt 42 having a T-knob 44 passes through the center of the fork mount 22. The mounting bolt 42 is used to removably attach the fork mount 22 to the base board 20. The mounting bolt 42 can for example be a 1/4-20 threaded fastener that mates with the ¼ inch threads of the aperture 49. The T-knob 44 enables easy attachment and removal of the fork mount 22 from the base board 20. The T-knob 44 is beneficially about one inch high and 1⅞ inch wide. This makes the overall assembled height of the mounting system 10 about 3 inches.

Around the mounting bolt 42 are two stabilizing pins 46 that are located such that they fit into the stabilizing holes 48 when the fork mount 22 is attached to the base board 20. For example, the stabilizing pins 46 might be 8-32×1 hanger bolts that are threaded into the fork mount 22 about 1 and ⅛ inch from the center of the mounting bolt 42 and on the center line of the fork mount 22. The stabilizing pins 46 can be held in place in the fork mount 22 using adhesive. Templates or CNC machines can be used to locate the spots. The stabilizing pins 46 assist a user in properly aligning the fork mount 22 on the base board 20, such that when the stabilizing pins 46 slide into the stabilizing holes 48, the user may rotate the T-knob 44 to secure the fork mount 22. The stabilizing pins 46 when inserted into the stabilizing holes 48 prevent the fork mount 22 from rotating or moving about.

When a bicycle 14 is attached to the mounting system 10 the front wheel is removed and the bicycle 14 front fork is attached to the fork mount 22. The mounting system 10 does not require the removal of the rear wheel. It is desirable to limit motion of the rear wheel during vehicle operation. Moreover, since the rear wheel can easily mar or soil vehicle interiors, protection is beneficial. Turning now to FIG. 1A and to FIGS. 4-5, the mounting system 10 includes a skid/scuff pad 16 which functions as a wheel anchor for securing the wheel of the bicycle 14 opposite the wheel fork and functions to help to prevent marring or soiling of the vehicle 12 interior. The skid/scuff pad 16 is attached to the appropriate location (reference the installation instructions provided below) on the vehicle 12 interior. Attachment of the skid/scuff pad 16 to the bicycle 14 wheel is made by a hook and loop strap 24. The skid/scuff pad 16 includes a perforated rubber pad 19 (illustratively 4 inch long) backed by a hook and loop fastener 17 including a loop strip 26 to be adhered to the vehicle 12 interior and a hook strip permanently affixed to the rubber pad. Two slots (illustratively ¾ inch slits that are separated by about an inch) are cut through the skid/scuff pad 16, and then a hook-and-loop strap 24 is passed through the two slits. The skid/scuff pad 16 is attached to the vehicle 12 interior, the front wheel of the bicycle 14 is removed, the front fork is placed on the fork mount 22, the hook-and-loop strap 24 of the skid/scuff pad 16 is used to grab and hold the rear wheel, and finally another hook-and-loop strap 24 can be used to attach the detached front wheel to the bicycle 14 frame.

The foregoing has described a mounting system 10 suitable for vertically carrying one bicycle inside a vehicle. Many vehicles have an interior space sufficient to enable vertically carrying two bicycles. FIG. 6 illustrates a base board 60 of a dual bicycle mounting system 11. The dual base board 60 is longer than the base board 20 used in the single bicycle mounting system 10. Illustratively the base board 60 is about 36 inches long and 8 inches wide, is ¾ inch thick, includes a ½ inch 45 degree beveled edge 34 (see FIG. 3) and a bottom edge 32 (see FIG. 2) that is a ¼ inch vertical edge. The bottom of the base board 60 includes the same hook-and-loop fasteners 70, 72 as the base board 20 except that the hook-and-loop fasteners 70, 72 are longer. Illustratively, 36 inch hook strips 72 and 37 inch loop strips 70 that overlap the hook strips 72 to leave ½ inch aprons.

Still referring to FIG. 6, the dual bicycle base board 60 has two threaded apertures 49, one toward each side end of the base board. Illustratively the apertures 49 are located 8 inches in from each side end along the centerline of the base board 60. As with the base board 20, if the base board 60 does not receive threads well, the aperture 49 can be made by countersunk holes, say 5/16 holes, then locating and gluing in place a ¼-20× 7/16 steel weld nut with having a 0.75 inch base. Templates or CNC machines will be used to locate the proper aperture 49 locations.

The base board 60 also includes two sets of stabilizing holes 48, with each set being symmetrically arranged around each aperture 49. The stabilizing holes 48 are located to receive the stabilizing pins 46 that extend from a fork mount 22. The stabilizing holes 48 and stabilizing pins 46 assist a user in aligning a fork mount 22 during installation on the base board 60 and to prevent the fork mount 22 from twisting once installed.

The same type of fork mount 22 is used with both the single bicycle mounting system 10 with the base board 20 and the dual bicycle mounting system 11 with the base board 60. The construction of the fork mounts 22 enable them to be removed simply by loosening the mounting bolt 42 using the T-knob 44. The fork mounts 22 can be made compact enough to be carried in a glove compartment or other small storage area. With the fork mount(s) 22 removed what remains is a base board 20 or 60 having a substantially flat surface 33, a small edge 32 and a beveled lip 34 that acts as a ramp that connects the edge 32 to the flat surface 33. That enables items such as groceries, luggage, boxes, and other items to be transported without any significant obstruction, allowing such items to be slid up over the lip 34 and across the base board 20 or 60.

The dual bicycle base board 60 and the base board 20 are preferably comprised of a polyethylene that can withstand −20 degrees Fahrenheit to +220 degrees Fahrenheit. The hook and loop strips and their adhesives can withstand temperatures at least from −20 to +220 degrees Fahrenheit. The various knobs 40 and 44 are preferably polypropylene capable of handling the same temperature range. The fasteners such as the mounting bolt 42, lugs 38 and nuts are preferably steel.

The bicycle mounting systems 10, 11 are configured to be easily installed in a variety of vehicles. To do so, a user opens the vehicle 12 to provide access to its interior space. A base board 20, 60 is placed on the vehicle floor. If the vehicle 12 is carpeted, that carpet should be secured to the floor by glue or mastic or some other attachment method. The carpet could also be cut, clipped, or removed. If the vehicle 12 has a hard floor such as plastic, steel etc. no preliminary work is required. However, it is best if the vehicle 12 floor is flat.

The base board 20, 60 is then set at a desired position, for example, in the case of an SUV near the back hatch. The knobs 40 are then loosened and the front wheel is removed from the bicycle 14 or bicycles 14 to be transported. The bicycle 14 is then rolled into the vehicle 12, back wheel first and the bicycle 14 front forks are located on the hanger bolts 38. Then, the front forks are secured to the fork mount 22 by tightening the knobs 40. With the bicycle 14, fork mount 22, and base board 20, 60 in the desired position a check is made to ensure that all doors and hatches can be closed with at least one inch clearance. If not, the desired position is adjusted until proper closures and clearances are obtained.

After the desired position is verified, framing stickers comprised of tape are used to frame out the base board 20, 60 location. This is performed by outlining the edges of the base board 20, 60 to show where the base board 20, 60 is to be placed. The bicycle 14 is then detached from the base board 20, 60 and both the bicycle 14 and base board 20, 60 are removed from the vehicle 12. Protective plastic release sheets on the loop strips 70 connected to the hook strips 72 on the bottom of the base board 20, 60 are then removed exposing adhesive. The base board 20, 60 is then placed back on the vehicle 12 floor at the location outlined by the framing stickers. The base board 20, 60 is then pressed down to be held in place by the adhesive on the loop strips 70, and the framing markers are removed.

With the base board 20, 60 installed, the bicycle 14 is then rolled back into the vehicle 12 rear wheel first. The bicycle 14 front forks are then attached to the frame mount 22 and the knobs 40 are tightened. The front wheel is then located against the bicycle 14 frame behind the handlebars and a first hook and loop strap 24 is used to attach the front wheel to the bicycle 14.

Next the skid/scuff pad 16 is placed under the rear wheel and secured to the vehicle 12 by removing a protective plastic release sheet from its hook and loop fastener 17 exposing an adhesive on the loop portion 26 of the hook and loop fastener 17. The skid/scuff pad 16 is then pressed into place at the appropriate location on interior surface of the vehicle 12, which may be for example on a folded down seat, an armrest, a console or the vehicle 14 floor. In cases where the appropriate interior surface of the vehicle 12 includes looped pile carpet or upholstery suitable for mating with the hook portion of the hook and loop fastener 17, the adhesive loop portion 26 of the hook and loop fastener 17 can be omitted, and the skid/scuff pad 16 can be attached to the appropriate interior surface directly via only a hook portion 25 of the hook and loop fastener 17. The hook-and-loop strap 24 of the skid/scuff pad 16 is then wrapped around the rear tire and rim to secure the rear of the bicycle 14.

The foregoing completes the initial installation of the bicycle mounting system. The base board 20, 60 and the skid/scuff pad 16 are left in place. To remove the bicycle 14 the front wheel is released by removing the first hook-and-loop straps 24, the rear wheel is released by undoing the hook and loop strap 24 of the skid/scuff pad 16, and the front fork of the bicycle 14 is then released from the fork mount 22 by undoing the knobs 40. The bicycle 14 is then removed. Finally, the fork mount(s) 22 is removed from the base board 20, 60 and stored. This leaves a substantially unobstructed vehicle 12 interior space permitting normal use of the vehicle interior. If desired, the base board 20, 60 can be removed leaving the loop strip 70 in place on the floor of the vehicle for future use. Likewise the skid/scuff pad 16 can be removed if desired leaving the loop portion 26 of the hook and loop fastener 17 attached in the vehicle 12 for future use.

While the foregoing has generally described installing the bicycle mounting systems, in practice some adjustments may be required. For example, because smaller SUVs and station wagons may have a narrow, tapered rear opening it may be required to tilt the bicycle 10 to 20 degrees at the rear opening. When used with particularly small vehicles 12 lowering or removal of the bicycle seat may be required. Furthermore, the illustrative dimensions may not be suitable for use with some vehicles 12 or some bicycles. In addition, with some vehicles 12 it may be possible to transport and store more than two bicycles. Therefore adjustments in dimensions to work with more bicycles are contemplated.

Finally it should be noted that while a preferred embodiment uses fork mounts 22 with lugs 38 and knobs 40 it is possible that in some applications the use of a quick release fork system mount may be beneficial. Such quick release fork systems are well known and widely used. In some applications such mounts are referred to as skewer mounts.

Thus while embodiments of the invention have been described in detail above, the invention is not limited to the specific embodiments described, which should be considered as merely exemplary. Further modifications and extensions of the invention may be developed, and all such modifications are deemed to be within the scope of the invention as defined by the appended claims.

What is claimed is:

1. A bicycle mounting system comprising:
a base board having a contact fastener;
a fork mount removably connected to the base board, the fork mount comprising:
a first bearing surface, a second bearing surface, and a third bearing surface opposite the second bearing surface;
a first threaded member;
a first hand knob connected to the first threaded member opposite the first bearing surface and between the second bearing surface and the third bearing surface;
a second threaded member extending from the second bearing surface;
a second hand knob connected to the second threaded member rotatable relative to the second bearing surface and translatable to and from the second bearing surface;
a third threaded member extending from the third bearing surface substantially axially aligned with the second threaded member; and
a third hand knob connected to the third threaded member rotatable relative to the third bearing surface and translatable to and from the third bearing surface;
wherein the fork mount is removably connected to the base board by the first threaded member, and wherein the first bearing surface is in removable contact with the base board opposite the contact fastener.

2. The bicycle mounting system of claim 1, wherein the contact fastener comprises at least one of an adhesive, a hook portion of a hook and loop fastener, and a loop portion of a hook and loop fastener.

3. The bicycle mounting system of claim 1, wherein the base board further comprises a threaded hole including threads corresponding to threads on the first threaded member for receiving the first threaded member for removably attaching the fork mount to the base board.

4. The bicycle mounting system of claim 1, wherein the base board comprises at least one alignment feature and the fork mount comprises at least one alignment feature configured to mate with the at least one alignment feature of the base board for positioning the fork mount relative to the base board.

5. The bicycle mounting system of claim 4, wherein the at least one alignment feature of the base board comprises at least one opening and the at least one alignment feature of the fork mount comprises at least one projection configured for removable positioning in the at least one opening.

6. The bicycle mounting system of claim 4, wherein the at least one alignment feature of the base board comprises at least two openings and the at least one alignment feature of the fork mount comprises at least two projections configured for removable positioning respectively in the at least two openings.

7. The bicycle mounting system of claim 1, wherein the fork mount comprises a first aperture in the first bearing surface through which the first threaded member passes.

8. The bicycle mounting system of claim 1, wherein the fork mount further comprises:
a second aperture in the second bearing surface in which the second threaded member is threadably received, wherein the second threaded member and second hand knob are translatable to and from the second bearing surface; and
a third aperture in the third bearing surface in which the third threaded member is threadably received, wherein the third threaded member and third hand knob are translatable to and from the second bearing surface.

9. The bicycle mounting system of claim 1, further comprising a wheel anchor for positioning distanced from the base board, the wheel anchor comprising:
a sheet of material;
a strap connected to the sheet of material; and
a contact fastener connected to the sheet of material.

10. The bicycle mounting system of claim 9, wherein the sheet of material is flexible.

11. The bicycle mounting system of claim 9, wherein the contact fastener comprises at least one of an adhesive, a hook portion of a hook and loop fastener, and a loop portion of a hook and loop fastener.

12. A bicycle mounting system comprising:
a base board comprising a contact fastener;
a fork mount removably connected to the base board, the fork mount comprising:
a first bearing surface and a second bearing surface;
a first threaded member;
a first hand knob connected to the first threaded member;
a second threaded member extending from the second bearing surface; and
a second hand knob connected to the second threaded member rotatable relative to the second bearing surface and translatable to and from the second bearing surface;
wherein the fork mount is removably connected to the base board by the first threaded member, the first bearing surface in removable contact with the base board opposite the contact fastener.

13. The bicycle mounting system of claim 12, further comprising:
a third bearing surface opposite the second bearing surface, wherein the first threaded member is disposed between the second bearing surface and the third bearing surface;
a third threaded member extending from the third bearing surface substantially axially aligned with the second threaded member; and
a third hand knob connected to the third threaded member rotatable relative to the third bearing surface and translatable to and from the third bearing surface.

14. A method for mounting a bicycle in a motor vehicle comprising:
providing a base board comprising a contact fastener and a threaded interface;
providing a fork mount comprising:
a first bearing surface and a second bearing surface;
a first threaded member extending in a first direction;
a first hand knob connected to the first threaded member;
a second threaded member extending from the second bearing surface in a second direction; and
a second hand knob connected to the second threaded member rotatable relative to the second bearing surface and translatable to and from the second bearing surface;
attaching the base board to an interior surface of a motor vehicle using the contact fastener;
connecting the fork mount to the base board with the first bearing surface of the fork mount in contact with the base board by engaging the first threaded member of the fork mount with the threaded interface of the base board by turning the first hand knob;
positioning a first leg of a wheel fork of a bicycle in contact with the second threaded member; and
securing the bicycle to the fork mount by turning the second hand knob to secure the first leg of the fork between the second hand knob and the second bearing surface.

15. The method of claim 14, further comprising:
providing the base board with:
a third bearing surface opposite the second bearing surface;
a third threaded member extending from the third bearing surface substantially axially aligned with the second threaded member; and
a third hand knob connected to the third threaded member rotatable relative to the third bearing surface and translatable to and from the third bearing surface;
positioning a second leg of the wheel fork of the bicycle in contact with the third threaded member; and
further securing the bicycle to the fork mount by turning the third hand knob to secure the second leg of the wheel fork between the third hand knob and the third bearing surface.

16. The method of claim 14, further comprising:
detaching the bicycle from the fork mount by turning the second hand knob to release the fork from between the second hand knob and the second bearing surface; and
disconnecting the fork mount from the base board by disengaging the first threaded member of the fork mount with the threaded interface of the base board by turning the first hand knob, wherein the base board remains attached to the interior surface of the motor vehicle.

17. The method of claim 14, further comprising:
providing the base board with at least one alignment feature; and
aligning the fork mount to the base board with the first bearing surface of the fork mount in contact with the base board using the at least one alignment feature prior to engaging the first threaded member of the fork mount with the threaded interface of the base board by turning the first hand knob.

18. The method of claim 14, further comprising
providing a wheel anchor comprising a sheet of material and a strap connected to the sheet of material;
attaching the wheel anchor to an interior feature of the motor vehicle distanced from the base board;
positioning a wheel of the bicycle opposite the fork in contact with the sheet of material; and
securing the wheel of the bicycle to the interior feature of the motor vehicle using the strap.

19. A bicycle mounting system, comprising:
a base board having a board bottom, a substantially flat board top, a perimeter edge, and an angled lip extending upward from the edge to the board top, the base board further including a threaded aperture into the board top and a stabilizing pin hole adjacent the threaded aperture;
a contact fastener on the board bottom; and
a fork mount having a body with a first side, a second side, a mount top, and a mount bottom, the fork mount further including a first threaded lug extending from the first side, a second threaded lug extending from the second side, a first knob threaded onto the first threaded lug, and a second knob threaded onto the second threaded lug, the fork mount further including a stabilizing pin extending from the mount bottom and a threaded fastener passing through the body from the mount top and extending from the mount bottom;
wherein the threaded fastener screws into the threaded aperture to attach the fork mount to the base plate; and
wherein the stabilizing pin fits into the stabilizing pin hole when the threaded fastener screws into the threaded aperture.

20. The bicycle mounting system of claim 19, wherein the threaded fastener includes a hand knob that assists screwing the threaded fastener into the threaded aperture.

21. The bicycle mounting system of claim 19, wherein the contact fastener includes adhesive and at least one of a hook fastener and a loop fastener.

22. The bicycle mounting system of claim 19, further comprising a skid/scuff pad comprising a sheet of material, a strap connected to the sheet of material, and a contact fastener connected to the sheet of material.

23. The bicycle mounting system of claim 22, wherein the strap includes a set of hook-and-loop fasteners.

24. A dual bicycle mounting system, comprising:
a base board having a board bottom, a substantially flat board top, a perimeter edge, and an angled lip extending upward from the edge to the board top, the base board further including a first threaded aperture into the board top, a first stabilizing pin hole adjacent the first threaded aperture, a second threaded aperture into the board top, and a second stabilizing pin hole adjacent the second threaded aperture;
a contact fastener on the board bottom; and
at least one fork mount having a body with a first side, a second side, a mount top, and a mount bottom, the at least one fork mount further including a first threaded lug extending from the first side a second threaded lug extending from the second side, a first knob threaded onto the first threaded lug, and a second knob threaded onto the second threaded lug, the at least one fork mount further including a stabilizing pin extending from the mount bottom and a threaded fastener passing through the body from the mount top and extending from the mount bottom;
wherein the threaded fastener screws into the first threaded aperture to attach the at least one fork mount to the base plate; and
wherein the stabilizing pin fits into the first stabilizing pin hole when the threaded fastener screws into the first threaded aperture.

25. The dual bicycle mounting system of claim 24, wherein the threaded fastener includes a hand knob that assists screwing the threaded fastener into the first threaded aperture.

26. The dual bicycle mounting system of claim 24, wherein the contact fastener includes adhesive and at least one of a hook fastener and a loop fastener.

27. The dual bicycle mounting system of claim 24, further comprising a skid/scuff pad comprising a sheet of material, a strap connected to the sheet of material, and a contact fastener connected to the sheet of material.

28. The dual bicycle mounting system of claim 27, wherein the strap includes a set of hook-and-loop fasteners.

29. A bicycle mounting system, comprising:
a base board having a board bottom, a substantially flat board top, a perimeter edge, and an angled lip extending upward from the edge to the board top, the base board further including a threaded aperture into the board top and a stabilizing pin hole adjacent the threaded aperture;
a contact fastener on the board bottom; and
a fork mount having a body with a first side, a second side, a mount top, and a mount bottom, the fork mount further including a first fork receiving member extending from the first side and a second fork receiving member extending from the second side, the fork mount further including a stabilizing pin extending from the mount bottom and a threaded fastener passing through the body from the mount top and extending from the mount bottom;
wherein the threaded fastener screws into the threaded aperture to attach the fork mount to the base plate; and
wherein the stabilizing pin fits into the stabilizing pin hole when the threaded fastener screws into the threaded aperture.
